(19) United States
(12) Patent Application Publication
(10) Pub. No.: US 2010/0012642 A1
(43) Pub. Date: Jan. 21, 2010

(54) HEATABLE ELEMENT

(76) Inventor: Heinz Zorn, Eggersdorf (AT)

Correspondence Address: CHAPMAN AND CUTLER, 111 WEST MONROE STREET, CHICAGO, IL, 60603, US

(21) Appl. No.: 12/448,316

(22) PCT Filed: Dec. 18, 2007
(86) PCT No.: PCT/AT2007/000569

§ 371 Date: Jul. 14, 2009

(30) Foreign Application Priority Data
Dec. 18, 2006 (AT) A 2081/2006

(51) Int. Cl. H05B 3/02

(52) U.S. Cl. 219/213; 219/542; 219/482

(57) ABSTRACT

In an element for producing an electrically heatable covering with connecting elements for connection of adjacent elements, the element (1) is connected to a multilayer printed circuit board (3) whose electrically conductive surface (4) facing the element (1) can be connected to an electrical contact (15) of a connecting or feed element (16), and whose outer side facing away from the element (1) is fitted with resistors (8), which are each arranged at a distance from one another, between metallic surfaces in the form of conductor tracks (11), wherein at least two conductor tracks (11) which are bridged by resistors (8) can be connected to electrical contacts (15) of a connecting or feed element (16).

The invention relates to an element for the production of an electrically heatable floor, ceiling or wall covering with connecting elements for the connection of adjacent elements.

Mostly, electrically heatable floor coverings are formed in such a way that mats with resistance wires are rolled out, wherein on such mats and as a rule particularly after embedding said mats in the floor fill, the final floor covering can be laid. Relating to wood floors, like e.g. parquet floors, in such installations care has to be taken, that local overheating is prevented in order to impede unwanted deformation. Temperature regulation of such floors however is mostly spanned over a whole mat, wherein the respective panels are then chosen as large as possible with regard to the expected placement effort for the electrical connections in order to minimise the number of electrical connections. In the known floor elements as a rule the heating element is laid separately from the floor covering to be placed subsequently, wherein appropriate levelling and adjusting is necessary in order to allow the desired planar contact between the heating element and the floor element and thus allow for a dissipation of heat as uniform as possible. All this requires a rather high placing effort. The electrical underfloor heatings known in the art use resistance wires of a meandering configuration which are embedded in a deformable base material, or plate structures in which the electrical resistors are formed by conductive coatings, and, in particular, by carbon containing resistance matter being embedded between the contacts. Accordingly, for safety reasons, the known installations can only be used for low voltages, which in turn again increases the cabling effort. In case of the corresponding lower voltages, obtaining the same electrical output requires employing electrical feed lines with a larger cross-section.

The invention now aims to create a heatable element of the initially mentioned kind, which can be laid without additional mounting effort in the same way as common floors like e.g. parquet floor, laminate or stone floors or otherwise in vertical placement, for example under plasterwork, wallpaper or a paint- or varnish layer, and which, after being laid, is immediately suitable for connection to the supply voltage present in each case without posing a safety risk. At the same time the invention aims to avoid the electromagnetic fields emerging in case of a meandering or arch-shaped placement of electrical conductors.

To address this issue, the heatable element according to the invention mainly consists in that the element is connected to a multilayer printed circuit board, whose electrically conductive surface facing the element can be connected to an electrical contact of a connecting- or feed element, and whose outer side facing away from the element is fitted with resistors, which are each arranged at a distance from one another, between metallic surfaces in the form of conductor tracks, whereby at least two conductor tracks which are bridged by resistors can be connected to electrical contacts of a connecting- or feed element. By designing the element's heating element according to a printed circuit, wherein the respective printed circuit boards have metal layers on both sides, it is possible to earth the surface adjacent to the element accordingly or to bring it to zero potential, such that in case of a subsequent damage—e.g. by spot-drilling with a drilling machine—the short circuit being possibly caused by the penetration of the metal layer having zero potential and the following contact with a conductive layer immediately leads to the activation of a fault-current protective switch (FI-switch) and thus poses no risk. Due to the fact that the voltage-carrying electrical conductors on the bottom side of the element each possess individual discrete resistors at a distance from one another, one creates the option to arrange said resistors at predetermined distances in such a way, that the heat is distributed in the best possible way and is accordingly dissipated via the metallic conductor tracks, such that a uniform temperature dissipation will be effected.

The individual conductor tracks and, respectively, the gaps between the conductor tracks, which are bridged by the resistors, may be straight or proceed in a meandering, wavelike, staggered or zigzag form, in order to achieve the most uniform distribution of the resistors over the surface to be heated. The conductor tracks of an element can herein at the same time be produced by stamping out a metal sheet.

The electrical cover of the bottom side can in turn be realized by means of a corresponding insulating profile, wherein the application of such an electrically insulating profile at the same time creates the opportunity that the electrical contacts for the connecting elements or feed elements can in a simple manner be devised pluggable, so that, during the installation, no special attention has to be paid to the electrical connection of the supply voltage, which connection has to be established subsequently. It will be sufficient to simply plug together the elements by the use of connecting elements and to lay them as usual, wherein only at the edges of the finally installed or mounted surface feed elements have to be plugged in subsequently. All in all, the design according to the invention with discrete resistors arranged at a distance from one another alongside the use of printed circuit boards allows for ensuring the required safety for the operation of such installations also with mains voltage, such that, as a consequence, the necessary electrical wiring can be kept especially simple.

In an especially advantageous manner, the inventive installation is realised in a way, that the electrical contacts are formed as plug connections, which can be plugged in a front side of the element. In contrast to known mats or other heatable elements the feed wires or cables, which—in case of excessive mechanical stress during installation—are also prone to breakage or failure, are omitted. The plug connections proposed according to the invention may each be accomplished in a way, that they abut the electrically conductive surfaces of the conductor tracks in a sliding manner, for which it is e.g. sufficient to form the insulating cover profile at the side facing away from the heated room with a corresponding channel-shaped recess, into which the connecting or feed element can be plugged in. Advantageously, the installation in this case is accomplished in a way that the plug connections have a stop shoulder in order to limit the insertion depth.

In order to reduce the danger of electrical short circuits due to increased humidity, the construction is advantageously accomplished such, that the stop shoulders are equipped with a sealing element, wherein, in a particularly favourable manner, the bottom side of the printed circuit board, which carries the resistors, is covered by an insulating plate, the front side of which features grooves being open to the conductor tracks for plugging-in of the plug connection. The insulating layer can here e.g. be stuck together with the bottom side of the printed circuit board carrying the resistors, so that the bottom side is completely sealed. The bottom side of the printed circuit board is thus protected from water entry.

The initially mentioned discrete resistors as they are used in printed circuits are commonly called “Surface Mounted Devices” (SMDs) and are characterised by a low construction height and a low loading capacity. As a rule, across such a resistor the power can drop by about ¼ watt without the resistor being destroyed. In order to dissipate this power optimally in the metallic conductor tracks, an accordingly small distance between adjacent conductor tracks is beneficial, for the heat not being distributed selectively within the insulated areas between adjacent conductor tracks, but in fact extensively by the thermal conduction of the conductor tracks. Such a small distance as it is desirable according to the invention in case of using supply power however, due to safety considerations, requires precautions which appropriately reduce the voltage between adjacent conductor tracks. According to the invention, this can be achieved by forming the resistors by SMDs wherein a plurality of resistors are arranged in parallel, and at least two resistors or groups of resistors respectively are arranged in serial. By the serial arrangement of resistors the voltage drop between adjacent conductor tracks is accordingly reduced in each case, so that for example in the case of distances of 1-1.5 mm or less than 1 mm between the individual conductor tracks under full supply power the apprehended electric breakdown path can not be formed since only an accordingly low voltage drop occurs.

The use of small and cheap resistors like e.g. SMDs allows for placing the resistors in corresponding numbers on the bottom side of the printed circuit board. Here, arrangements of 400-500 resistors per m² are preferred.

In a particularly preferred manner the contacting of adjacent elements is accomplished in such a way, that the grooves are formed as grooves extending over the length of the elements and accommodate rods, which are movable in the longitudinal direction and the ends of which are realized as bridge contacts to electrically connect adjacent elements when the rods are pulled out. This construction thus already comprises in each element respective connecting elements in the form of movable plug connections, so that, strictly speaking, only one separate feed element has to be connected at the edge of the installed surface for a multitude of longitudinally interconnected elements. This construction is also especially suitable to cut the respective floor element to a desired length without impairing its function since the subsequent installation will be accomplished in the same way as for an uncut, complete element. The movable rods except for the contact area may here be made of a non-conductive material like e.g. rigid foam. The rods are preferably thus constructed that they completely occupy the grooves' cross-section.

For the improved heat dissipation by the metallic conductor tracks, the installation is preferably constructed such that the distance of adjacent planar conductor tracks is chosen smaller than 1.5 mm, preferably smaller than 1 mm, wherein, preferably, serially arranged resistors in adjacent rows are positioned in a staggered relation with one another.

In keeping with the previously mentioned safety precautions and especially by use of the corresponding serial arrangements the installation according to the invention can be accomplished such that the operating voltage is chosen as being equal to the supply voltage.

Especially favourable in the context of employing the inventive heatable elements is the fact that the individual elements can be separately protected against overheating and—by an accordingly simple arrangement—may also be separately controlled by switching. This is particularly interesting if e.g. fixtures are subsequently moved on such an electrically heated parquet floor and if heating power is e.g. not to be applied under a box or under a bed, but only in the remaining areas. Addressing the individual elements in a discrete manner may also be favourably employed to reduce energy consumption and to increase the heat output during the initial operating period after switching on.

Advantageously, the installation is hereby formed such that each floor element contains at least one switch, which is serially arranged with respect to the resistors, wherein the switch(es) is/are preferably realized as (a) bi-metal switch(es) in order to prevent excess temperatures. Such switches may of course also be realized as “Triac” or “Thyristor” and—together with a corresponding control logic—may react either to temperature signals of a thermistor or to control signals, wherein the installation is favourably realized such that the switch(es) is/are implemented as remote switch(es) and is/are connected with an evaluating logic for evaluating the control signals.

The protection switches can preferably be incorporated within the plug connector in order to minimize the expense with structural members and to simplify production. Such integration of the switch within the plug connector moreover ensures that the protection switch will still work when parts of the elements have been cut off.

Favourably, the heatable elements according to the invention may be arranged in a plurality of edgewise adjoining parallel rows. In this context, a method for heating a room by means of a plurality of heatable floor or wall elements, which are arranged in edgewise adjoining parallel rows is characterised in that the elements of a first group of rows and the elements of a second group of rows, which are arranged between the rows of the first group of rows in each case, are heated in an alternating fashion at a time. This means that in case of a configuration having e.g. four rows at first the elements of the first row and third row are heated, followed by the elements of the second row and fourth row, whereupon this cycle is repeated. The cycle time here is preferably 15-20 min. It has been shown that the current consumption can be divided in half by use of such a heating method, wherein the heat output in comparison to a simultaneous heating of all elements only decreases by about 20%. This effect is especially to be found in heating elements having a low inertia and therefore the heating method is preferably performed by use of SMDs as heating elements for the heatable floor or wall elements. In the context of the heating method elements according to one of claims 1 to 14 are preferably employed. The respective heated rows are also able to co-heat the respective unheated row positioned between the heated rows.

In the following the invention is described in more detail by means of an embodiment schematically depicted in the drawings.

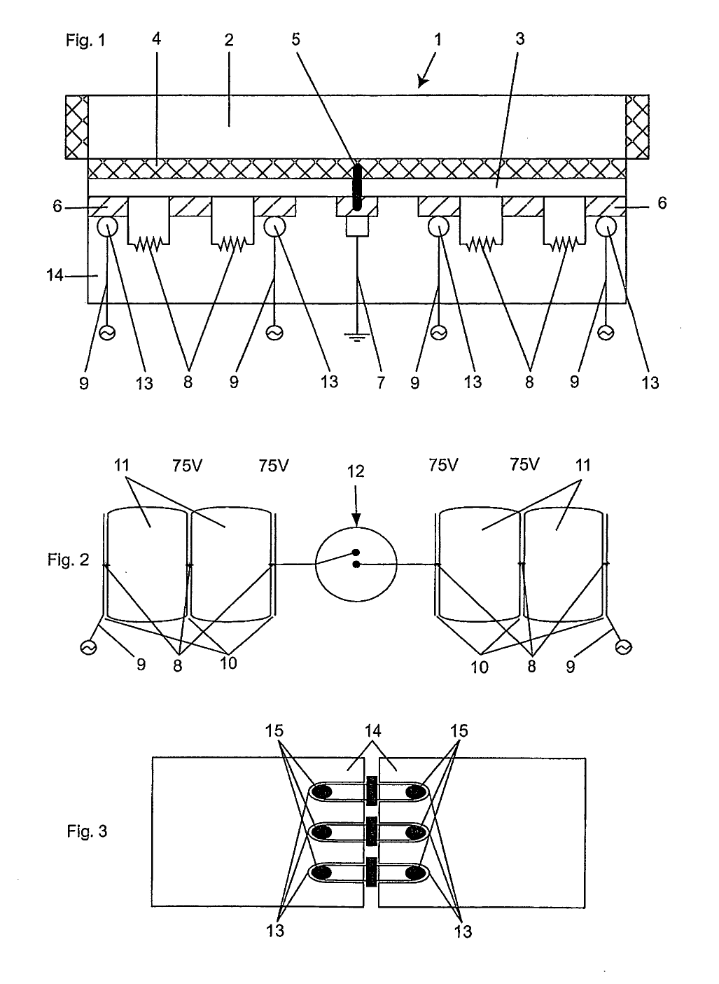

Therein, FIG. 1 shows a cross-section through a heatable element according to the invention being realized as a parquet slat,

FIG. 2 shows a schematic depiction of the electrical switching system of the heating elements,

FIG. 3 shows a detailed view of an electrical connection between adjacent elements,

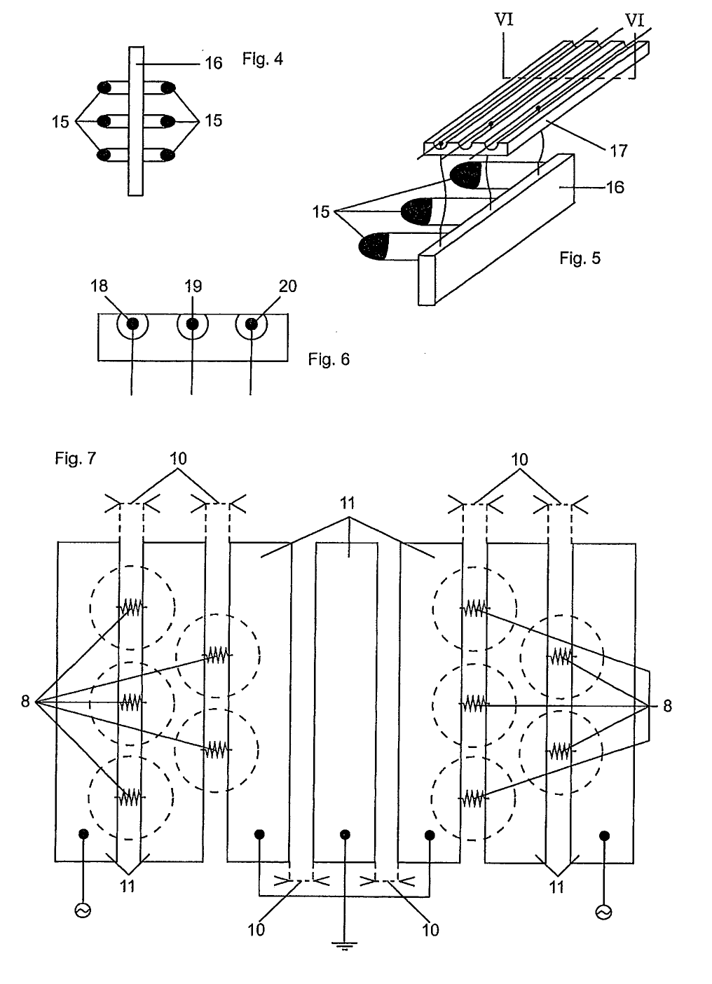

FIG. 4 shows a detailed view of a connecting element,

FIG. 5 shows a perspective view of a feed element,

FIG. 6 shows a cross-section through the electrical connections according to the section VI-VI of FIG. 5, and

FIG. 7 shows a bottom view onto the element according to FIG. 1 with the insulating cover being removed.

In FIG. 1 number 1 schematically depicts a heating element whose wearing surface or cover layer is formed by a parquet slat 2. The kind of covering however is not crucial for the inventive heating. The covering may as well be one of wall or ceiling elements, and in particular it may consist of natural stone plates, artificial stone plates, ceramic plates, laminate plates or the like or it may consist of glass, porcelain, fireproof papers like wallpapers, plasterboard or other materials. Connected to this covering being subjected or exposed to external effects, in particular to wear and tear, is a printed circuit board 3, which has a three-layered structure. The upper side facing the covering consists of metallically conductive material, and in particular of copper, but here it is most important, that it is a conductive metallic coating. This metallic layer 4 is connected to the similarly metallic layer 6 on the bottom side of the printed circuit board via a connection 5, so that in this position, as it is schematically indicated with 7, an electrical plug connection to a zero potential conductor or to the ground can be implemented, so that the metal layer 4 is at zero potential. The bottom side of the printed circuit board 3 facing away from the covering carries the discrete electrical resistors 8, wherein the feed of supply voltage may respectively be achieved by means of plug connections schematically indicated with 9. The electrical circuit diagram here is shown in FIG. 2, wherein in this electrical circuit, respectively, the outer conductor tracks are connected to supply voltage, and where in each case maximally a fourth of the supply voltage drops across the serially arranged resistors 8, so that the gap (indicated with 10) between adjacent conductor tracks 11 can be kept accordingly small without having to fear a flashover. This accordingly small distance has as a consequence that the electrical resistors 8 reach over the whole width of the gap and partly also get directly into mechanical contact with adjacent conductor tracks 11, so that the heat is accordingly dissipated in a better way.

Further on, the installation according to FIG. 2 schematically shows an electrical switch, which is schematically indicated with 12. The electrical switch 12 can be provided in an accordingly higher number per element, wherein the elements, when placing one switch 12 each close to the front sides of such elements would completely retain their function even under subsequent shortening of these elements for adapting them to room shape, because the other switch 12 takes over this function. In the closed state of said switch 12 current will thus flow across the two conductors 9 and the serially arranged resistors 8, wherein said current will then be transformed into heat by the resistors. The low performance of the individual resistors requires an accordingly larger number of resistors over the whole surface.

The electrical connection of adjacent floor elements is schematically shown in FIG. 3. The electrical contacts 15 each being inserted in the grooves 13 of an electrically insulating cover or plate 14 are shown as top view in FIG. 3, wherein the corresponding grooves or channels of the electrically insulating cover are shown in cross-section in FIG. 1. According to the front side feed, the contacts 15 are each alternatively connected with a voltage source or the neutral conductor, wherein this configuration in consequence applies to all the longitudinally interconnected elements. A magnified depiction of such connecting element is shown in FIG. 4, wherein the contacts again are indicated with 15 and have a stop element 16 in order to limit the drive in or insertion depth. This stop element 16 may also simultaneously become active as an accordingly deformable sealing material, so that the front sides of adjacent floor elements can be effectively protected from water entry.

A corresponding feed element or connecting element 16 having a plurality of electrical plug connections 15 is depicted in FIG. 5. These plug connections 15 are plugged in at the end adjacent to a wall and are guided by wires to an adaptor 17, into which—after completion of the whole installation—the electrical conductors are inserted and then connected in a simple way. Until the electrical connection is established it is sufficient to test the operative readiness of the elements being each longitudinally interconnected by simple and quick resistance measurements, wherein in the following, as it is depicted in FIG. 6, one just has to electrically connect the electrical braids or wires 18, 19 and 20 in accordance with the neutral conductor, the ground and the phase, uniformly for all elements by simple crimping with the feed element 16. The effort for electrical installation is thus reduced to a minimum, and it is sufficient to install the breakage prone electrical feed lines as ring lines near to the wall side end, wherein here—due to the mandatory thermal expansion joints—there also is available a corresponding space to accommodate these conductors in a mechanically protected manner.

Monitoring the resistance values may also be done during operation in order to detect malfunction.

In FIG. 7 it becomes clear that the resistors 8 being arranged between adjacent conductor tracks 11 bridge the electrically insulating gap between said conductor tracks 11 so that also a corresponding thermal conductivity to the respective planar conductor tracks 11 is ensured. Resistors 8, which are arranged in adjacent rows and in a serial manner with one another, are here, as it can be seen in FIG. 7, positioned in a staggered relation with one another in order to accordingly promote and equalize heat spreading schematically indicated by circles 21 over the surface.

The bridging of the neutral conductor or mass to realize the serial arrangement—wherein the bridging is schematically depicted as a wire connection in FIG. 7—is of course established by a corresponding switch, as it is evident from FIG. 2 but which is, for reasons of clarity, not depicted in FIG. 7.

1. An element for producing an electrically heatable covering with connecting elements for connection of adjacent elements, wherein the element (1) is connected to a multilayer printed circuit board (3) whose electrically conductive surface (4) facing the element (1) can be connected to an electrical contact (15) of a connecting or feed element (16), and whose outer side facing away from the element (1) is fitted with resistors (8), which are each arranged at a distance from one another, between metallic surfaces in the form of conductor tracks (11), wherein at least two conductor tracks (11) which are bridged by resistors (8) can be connected to electrical contacts (15) of a connecting or feed element (16).

2. The element according to claim 1, wherein the electrical contacts (15) are accomplished as plug connections, which can be plugged in a front side of the element (1).

3. The element according to claim 1, wherein the plug connections have a stop shoulder (16) in order to limit the insertion depth.

4. The element according to claim 1, wherein the stop shoulders (16) are equipped with a sealing element.

5. The element according to claim 1, wherein the resistors (8) are realized as SMDs, wherein a plurality of resistors (8) are arranged in a parallel manner, and in each case at least two resistors (8) or groups of resistors (8) are arranged in a serial manner.

6. The element according to claim 1, wherein the bottom side of the printed circuit board (3), which carries the resistors (8), is covered by an insulating plate (14), the front side of which exhibits grooves (13) being open to conductor tracks (11) for the plugging-in of the plug connectors.

7. Floor element according to clam 1, wherein the grooves (13) are formed as grooves extending over the length of the elements (1) and accommodate rods, which are movable in the longitudinal direction and the ends of which are realized as bridge contacts to electrically connect adjacent elements (1) when the rods are pulled out.

8. The element according to claim 1, wherein the distance of adjacent planar conductor tracks (11) is chosen as being smaller than 1.5 mm, preferably smaller than 1 mm.

9. The element according to claim 1, wherein resistors (8), which are arranged in rows, are positioned in a staggered relation with one another in adjacent rows.

10. The element according to claim 1, wherein the operating voltage is chosen as being equal to the supply voltage.

11. The element according to claim 1, wherein each element contains at least one switch (12), which is arranged in a serial manner with the resistors.

12. The element according to claim 11, wherein the switch(es) (12) is/are realized as bi-metal switches.

13. The element according to claim 11, wherein the switch(es) (12) is/are implemented as remote switches and is/are connected with an evaluating logic for evaluating the control signals.

14. The element according to claim 1, wherein the resistors (8) are arranged with a density of more than 300 pieces, preferably with 400-500 pieces, per m².

15. Method for heating a room by means of a plurality of heatable floor or wall elements, which are arranged in edgewise adjoining parallel rows, wherein the elements of a first group of rows and the elements of a second group of rows, which are each arranged between the rows of the first group of rows in each case, are heated in an alternating fashion at a time.

16. Method according to claim 15, wherein the heating of the floor or wall elements is performed by use of SMDs.

17. Method for heating a room by means of a plurality of heatable floor or wall elements, which are arranged in edgewise adjoining parallel rows, wherein the elements of a first group of rows and the elements of a second group of rows, which are each arranged between the rows of the first group of rows in each case, are heated in an alternating fashion at a time, and wherein as heatable floor or wall elements according to claim 1 are employed.

18. The element according to claim 2, wherein the plug connections have a stop shoulder (16) in order to limit the insertion depth.

19. The element according to claim 2, wherein the stop shoulders (16) are equipped with a sealing element.

20. The element according to claim 3, wherein the stop shoulders (16) are equipped with a sealing element.
